(19) United States
(12) Patent Application Publication
(10) Pub. No.: US 2011/0163020 A1
(43) Pub. Date: Jul. 7, 2011

(54) Effluent Weir

(76) Inventor: Stuart Johnathan Ward, Camas, WA (US)

(21) Appl. No.: 12/683,340

(22) Filed: Jan. 6, 2010

(51) Int. Cl. B01D 21/28; B01D 21/34

(52) U.S. Cl. 210/137; 210/541

(57) ABSTRACT

Device for removing clarified liquid effluent from process and wastewater equipment vessels. The device includes a horizontal square pipe with a perpendicular adjustable height riser. The device is to be used singularly or in a multiple unit parallel arrangement with process or wastewater equipment as a means of optimizing the fluid level within the vessel while evacuating clarified fluid without attendant particulate within the fluid solution being carried out or fouling the device from said particles.

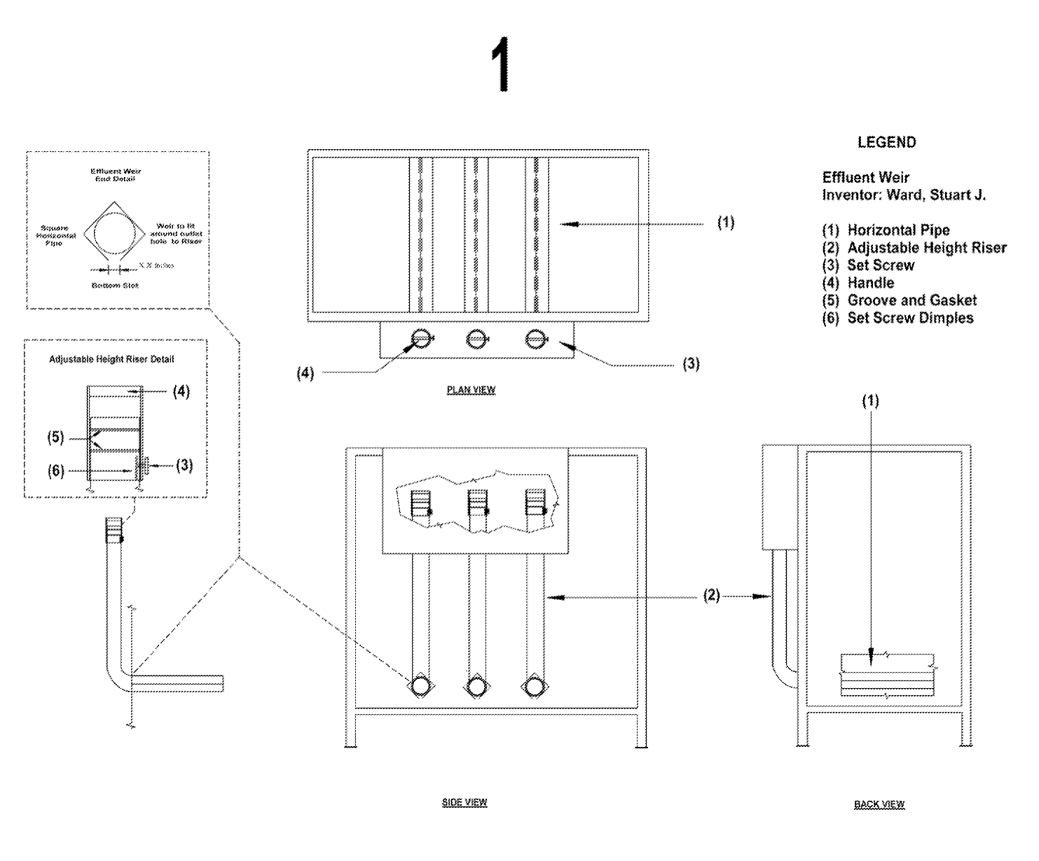

The subject of the present invention is a device for removing clarified liquid effluent from process and wastewater equipment vessels, such as may be used for and not limited to potable water clarification, wastewater clarification, oil/water separation or other liquid process equipment.

At present, there are any number of other mechanical methods for achieving the above described process.

Schematically, the principal removal steps within a process or wastewater equipment vessel is the collection of the clarified effluent at an exit baffle, pipe, port or simple overflow point; the subsequent separation of the fluid behind the baffle, into the pipe, at the port or over the weir point; and the final transport of that fluid away from the vessel interior for further processing or discharge.

A number of problems arise with existing methods, in particular the pipe method. Existing pipe technology utilizes a circular pipe with annular perforations allowing entry of the effluent fluid. There are two specific issues arising from this method. The pipe allows the collection and fouling of settle-able particulate contained in the fluid solution within the pipe's interior area along the horizontal base of the pipe. The pipe also allows the collection and fouling of settle-able particulate along their exterior top surface. Both the interior and exterior particular build-up result in periodic discharges of large particulate solids with the effluent. The interior build-up also constricts the flow of effluent fluid through the pipe.

For several years, a certain number of methods and devices have been studied in order to improve the clarified fluid extraction process.

One solution to the particulate solids collection and fouling problem according to the invention would be to use a square pipe arranged horizontally with a longitudinal corner at the apex position and a full slot perforating the length of the pipe along the bottom base position.

The object of the present invention is therefore to resolve the aforementioned problem in an economical manner by providing 45 degree sloped surfaces along the top of the pipe to allow particles to slide off the top exterior, and by providing 45 degree sloped surfaces along the interior of the pipe to allow particles to slide out of the interior of the pipe through the base slot while the clarified effluent fluid flows into and within the pipe.

Final extraction of the clarified effluent fluid from the vessel is accomplished when the fluid flows within the horizontal pipe and up through adjustable height riser weir.

The set screw position selected by the operator of the adjustable height riser weir determines the fluid level height within the equipment vessel.

Thus, in accordance with the present invention there is a removal of clarified effluent fluid while leaving settle-able particles within the vessel.

The device according to the invention is furthermore operated on a continuous flow basis within a fluid operating temperature of 32 F to 210 F.

The clarified effluent fluid may be collected for further processing within a catch basin or simply flow to discharge.

One embodiment of the present invention is described hereafter with reference to the attached single DRAWING which is a schematic representation of the device according to the invention.

A description of the DRAWING illustrates the object of the “effluent weir” device is to provide clarified liquid effluent from process and wastewater equipment vessels. For this purpose the device includes a horizontal square pipe (1) with a perpendicular adjustable height riser (2). The device is to be used singularly or in a multiple unit parallel arrangement with process or wastewater equipment as a means of optimizing the fluid level within the vessel while evacuating clarified fluid without attendant particulate within the fluid solution being carried out or fouling the device from said particles.

The fluid within the vessel would enter a square pipe arranged horizontally (1) with a longitudinal corner at the apex position and a full slot perforating the length of the pipe along the bottom base position.

The clarified effluent fluid would flow within the horizontal pipe (1) and up through an adjustable height riser weir (2).

The set screw position (3) among the dimples (6) selected by the operator of the adjustable height riser weir (2) determines the fluid level height within the equipment vessel.

The handle (4) provides a means of grasping and controlling the effluent riser weir by the operator.

The groove and gasket (5) provides a seal and alignment mechanism on the adjustable riser weir.

I claim:

1. Device for removing clarified liquid effluent from process and wastewater equipment. The device comprises the components of a horizontal square pipe with a perpendicular adjustable height riser, collectively known as an “effluent weir”.

2. Device according to claim 1, characterized in that it may comprise furthermore one or more parallel “effluent weirs”, the number of which depends upon the fluid volume contained in the process or wastewater equipment vessel and the effluent removal flow rate requirements from said vessel.

3. Device according to claim 1, characterized in that it comprises furthermore the horizontal pipe is arranged below the surface of the fluid with its perpendicular adjustable height riser arranged vertically above the horizontal pipe.

4. Device according to claim 1, characterized in that it comprises furthermore that the horizontal pipe is arranged with its respective orientation such that the pipe's longitudinal corner forms an apex at the top.

5. Device according to claim 1, characterized in that it comprises furthermore that the horizontal pipe has a lengthwise slot along its entire bottom base to permit the entry and flow of effluent fluid, such that the slot be of sufficient width to optimize effluent flow.

6. Device according to claim 1, characterized in that it comprises furthermore the horizontal pipe may have a single enclosed end and be of a fixed length extending into the vessel, or that it may extend fully across the vessel with its extended end attached and sealed at the vessel wall.

7. Device according to claim 1, characterized in that it comprises furthermore the horizontal pipe be attached and sealed around its circumference where the pipe pierces the equipment vessel wall.

8. Device according to claim 1, characterized in that it comprises furthermore the adjustable height perpendicular riser may be of square or cylindrical form.

9. Device according to claim 1, characterized in that it comprises furthermore the adjustable height perpendicular riser may or may not necessarily enter an adjacent effluent catch basin for further directing the effluent flow.

10. Device according to claim 1, characterized in that it comprises furthermore the adjustable height perpendicular riser with the following subcomponents: 1) the riser pipe itself has two or more scored grooves around it's circumference for holding sealing gaskets and multiple vertically arranged scored dimples along one side for accepting a set screw; and 2) have a separate adjustable weir fitted around the exterior of the riser; with said weir having a handle to grasp it and a set screw for affixing the weir in place on the riser.
